(19) United States
(12) Patent Application Publication
(10) Pub. No.: US 2007/0194077 A1
(43) Pub. Date: Aug. 23, 2007

(54) Safety device for nailers

(75) Inventor: Yi Kuan Lee, Ta-Li City (TW)

Correspondence Address: CHARLES E. BAXLEY, ESQ., 90 JOHN STREET, THIRD FLOOR, NEW YORK, NY, 10038, US

(73) Assignee: Samson Power Tool Co., Ltd.

(21) Appl. No.: 11/708,942

(22) Filed: Feb. 20, 2007

(30) Foreign Application Priority Data
Feb. 20, 2006 (TW) 95105653

(51) Int. Cl. B25C 5/06

(52) U.S. Cl. 227/8; 227/120

(57) ABSTRACT

A safety device for a nailer includes a pushing end located at a first end of the safety device and the pushing end is movably inserted into the nose or the magazine and located beside heads of the nails. A second end of the safety device is biased by a spring and located beside the plate of the trigger unit of the nailer. One of the nails in the passage 40 has its tip extending out from the nose and when the tip is pushed to against the object to be nailed, the nails are shifted a distance and push the pushing end of the safety device to activate the plate of the trigger unit. When the trigger unit is pulled, the valve unit is activated and the nail that contacts against the object is precisely sent into the object.

### FIELD OF THE INVENTION

The present invention relates to a safety device for a nailer and includes a push end movably located in beside the heads of the nails which directly push the push end to release the locked status of the trigger unit.

### BACKGROUND OF THE INVENTION

A conventional nailer is shown in FIG. 1 and generally includes a barrel 10 with a handle 101 in which a valve unit 15 is connected and a trigger unit 12 is pivotably connected to the barrel 10 and located beside an activation rod 150 of the valve unit 15. A nose 11 is connected to the barrel 10 and includes a path 110 in which a nail is received and to be ejected out from the nose 11 by a pushing rod powered by pneumatic power when the valve unit 15 is activated. A magazine 13 is connected to the nose 13 and a pushing member 14 is received therein which is pushed by a spring (not shown) so as to push the nails 130 toward the nose 13. A safety device 16 is a link system which can be moved along the nose 11 and biased by a spring 17 connected between one of the links of the safety device 17 and the barrel 10 so that a distal end of the link of the safety device 16 beside the nose 11 is normally extended beyond the distal end of the nose 11. The user has to push the safety device 16 to against the object 2 to be nailed so that the other end of the safety device 16 pushes the plate 120 of the trigger unit 12 as shown in FIG. 2. The plate 120 is moved to close to contact the activation rod 150 so that when the user pulls the trigger unit 12 as shown in FIG. 3, the valve unit 15 is activated and the pressurized air activates the pushing rod to eject a nail into the object 2. However, because the safety device 16 is located beside the nose 11 and has to be pushed against the object 2 to be nailed, the user cannot see the desired point on the object 2 because the safety device 16 blocks a part of the object 2. Eventually, the nails 130 cannot be nailed to desired points. The problem is typically obvious when the nail 130 is to be nailed into a recessed area of the object 2.

The present invention intends to provide a safety device for a nailer wherein the safety device is pushed by directly pushing the nail against the object to be nailed. The safety device is inserted into the nose or the magazine so that the user can see the object completely.

### SUMMARY OF THE INVENTION

The present invention relates to a nailer that comprises a barrel having a valve unit connected to the handle of the nailer and the valve unit has an activation rod. A trigger unit is connected to the barrel and has a plate which is located beside the activation rod handle. A nose is connected to the barrel and includes a passage defined axially therethrough so that nails are respectively pushed into the passage. A magazine for receiving the nails is connected with the nose and a tip of one of the nails is located in the passage in the nose extends out from the nose. A safety device has a pushing end at a first end thereof and the pushing end is movably inserted into the nose and located beside heads of the nails in the nose. A second end of the safety device is biased by a spring and located beside the plate of the trigger unit. The second end of the safety device is pushed toward the plate of the trigger unit when the tip of the nail outside of the nose is pushed to contact against the object to be nailed.

The primary object of the present invention is to provide a safety device for a nailer and the safety device includes a pushing end which is directly pushed by the heads of the nails to release the locked status of the nailer when the first nail that extends out from the nose is pushed against the object to be nailed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional safety device of a nailer wherein the conventional safety device has not yet pushed to contact against the object;

FIG. 2 shows that the conventional safety device is pushed to contact against the object;

FIG. 3 shows that the trigger unit of the nailer in FIG. 2 is pulled to eject the nail in the nose;

FIG. 4 shows the nailer equipped with the safety device of the present invention;

FIG. 5 shows that the nail extending outside the nose of the nailer of the present invention is pushed to contact against the object to be nailed;

FIG. 6 shows that the trigger unit is pulled and the nail in the nose is nailed into the object;

FIG. 7 the second embodiment of the safety device of the nailer of the present invention;

FIG. 8 shows that the nail extending outside the nose of the nailer in FIG. 7 is pushed to contact against the object to be nailed, and

FIG. 9 shows that the trigger unit is pulled and the nail in the nose is nailed into the object.

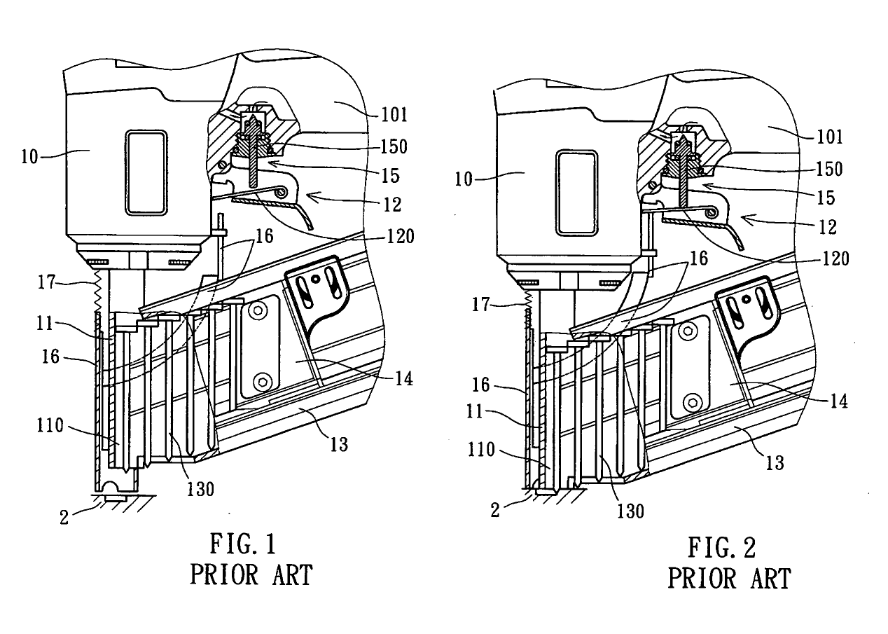

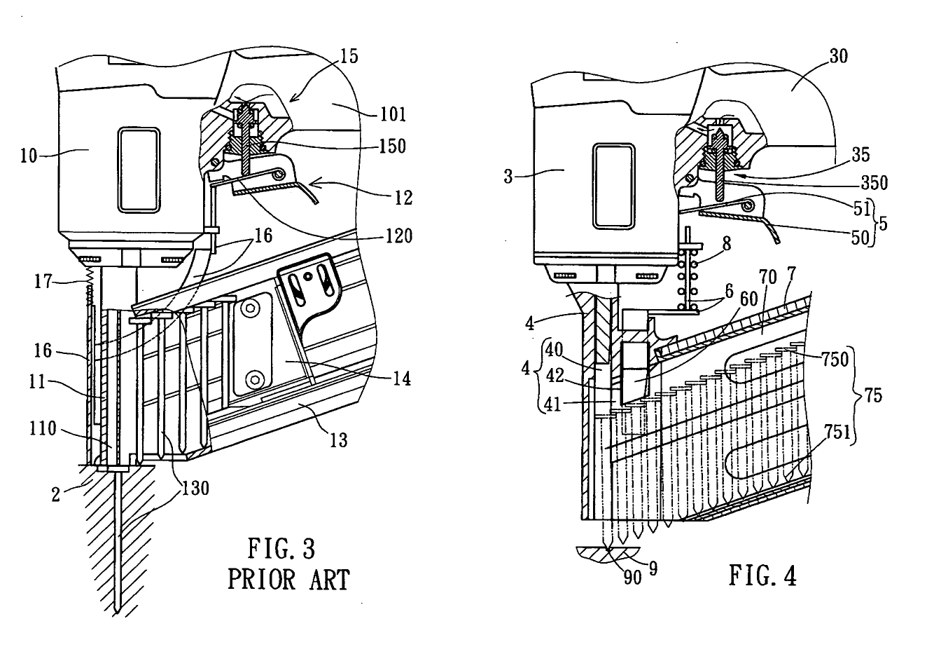

### DETAILED DESCRIPTION OF THE PREFERRED EMBODIMENT

Referring to FIG. 4, the nailer of the present invention comprises a barrel 3 having a handle 30 at one end thereof and a nose 4 is connected to the other end of the barrel 3. A valve unit 35 is connected to the handle 30 and has an activation rod 350, the valve unit 35 controls the path that introduces pressurized air into the barrel 3 and the nose 4 from a compressor which is connected to the handle 3. A trigger unit 5 is connected to the barrel 3 and has a plate 51 which is located beside the activation rod 350 at a distance. The nose 4 has a passage 40 defined axially therethrough and an communication port 41 is defined radially therethrough.

A magazine 7 is connected with the nose 4 and has a receiving space 70 in which nails 75 are received. The receiving space 70 communicates with the communication port 41 and the first one of the nails 75 is located in the passage 40 in the nose 4 and a tip of the nail 75 extends out from the nose 4.

A safety device 6 has a pushing end 60 at a first end thereof and the pushing end 60 is movably inserted into the nose 4 and located beside heads 750 of the nails 75 in the nose 4. The nose 4 includes a guide space 42 in which the pushing end 60 of the safety device 6 is movably received therein, the guide space 42 ensures that the pushing end 60 can be moved linearly. A second end of the safety device 6 is biased by a spring 8 and located beside the plate 51 of the trigger unit 5.

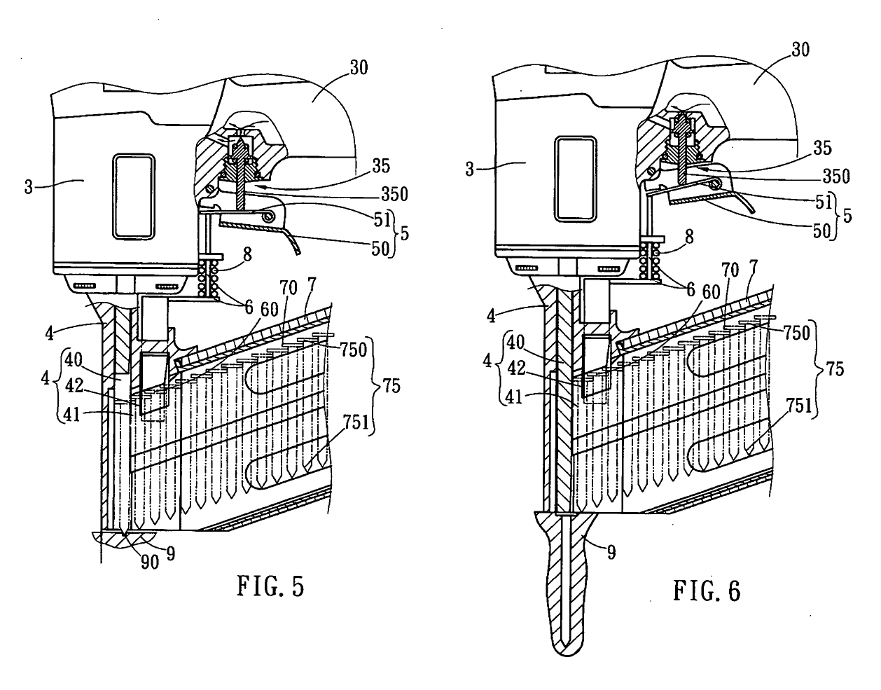

As shown in FIGS. 5 and 6, when using the nailer, the tip 751 of the nail 70 that extends out from the nose 4 is pushed to contact against the inner end of the recess 90 of the object 9 to be nailed. Because the nails 75 are connected with each other so that the nails 75 are shifted a distance and the heads 750 of the nails 75 push the pushing end 60 to compress the spring 8. The second end of the safety device 6 is then pushed toward the plate 51 which is pivoted about the pivot at the trigger 50 and contacts the activation rod 350. The user then pulls the trigger 50 so that the plate 51 pushes the activation rod 350 to release the locked status of the nailer. The nail 75 in the passage 40 is then ejected out from the nose 4 and precisely nailed into the object 9 as desired.

It is noted that the pushing end 60 is located between the nose 4 and the magazine 7 so that the user can see the recess 90 of the object 9 clearly and the tip 751 of the nail 75 is directly in contact with the point of the desired position of the object 9 so that the nail 75 is ensured to be nailed at the desired position.

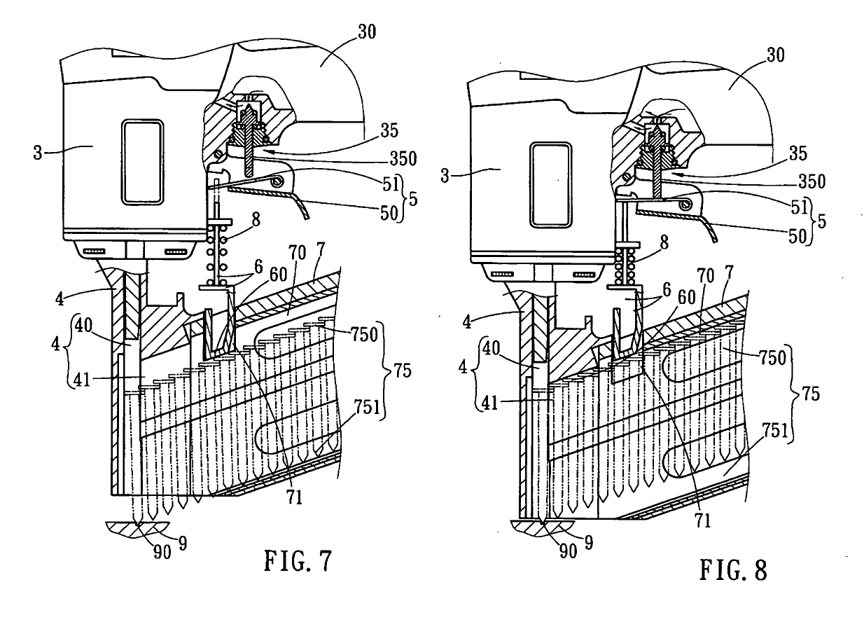

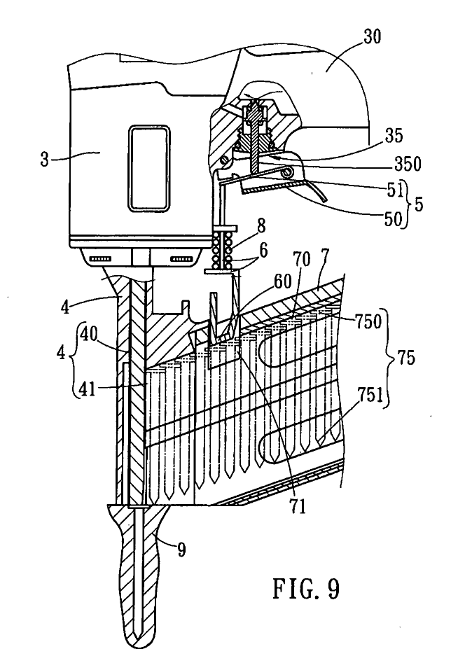

FIGS. 7 to 9 show the second embodiment of the safety device 6 of the present invention wherein the differences from the first embodiment disclosed in FIGS. 4 to 6 are the nose 4 of the second embodiment does not have the guide space 42 as disclosed in the first embodiment and the magazine 7 in the second embodiment has a hole 71 defined through a wall of the magazine 7. The pushing end 60 of the safety device 6 is movably inserted into the hole 71 and located beside heads 750 of the nails 75 in the magazine 7. The pushing end 60 is located between the magazine 7 and the trigger unit 5 so that it does not block the user's view.

While we have shown and described the embodiment in accordance with the present invention, it should be clear to those skilled in the art that further embodiments may be made without departing from the scope of the present invention.

What is claimed is:

1. A nailer comprising:
a barrel having a handle at one end thereof and a nose connected to the other end of the barrel, a valve unit connected to the handle and having an activation rod, a trigger unit connected to the barrel and having a plate which is located beside the activation rod, the nose having a passage defined axially therethrough and an communication port defined radially therethrough;
a magazine connected with the nose and having a receiving space in which nails are received, the receiving space communicating with the communication port, one of the nails located in the passage in the nose and a tip of the nail extending out from the nose, and
a safety device having a pushing end at a first end thereof, the pushing end movably inserted into the nose and located beside heads of the nails in the nose, a second end of the safety device biased by a spring and located beside the plate of the trigger unit.

2. The nailer as claimed in claim 1, wherein the nose includes a guide space in which the pushing end of the safety device is movably received therein.

3. The nailer as claimed in claim 1, wherein the pushing end of the safety device is pushed toward the heads of the nails by the spring.

4. The nailer as claimed in claim 1, wherein the pushing end is located between the nose and the magazine.

5. A nailer comprising:
a barrel having a handle at one end thereof and a nose connected to the other end of the barrel, a valve unit connected to the handle and having an activation rod, a trigger unit connected to the barrel and having a plate which is located beside the activation rod, the nose having a passage defined axially therethrough and an communication port defined radially therethrough;
a magazine connected with the nose and having a receiving space in which nails are received, the receiving space communicating with the communication port, one of the nails located in the passage in the nose and a tip of the nail in the passage extending out from the nose, and
a safety device having a pushing end at a first end thereof, the pushing end movably inserted into a hole defined through a wall of the magazine and located beside heads of the nails in the magazine, a second end of the safety device biased by a spring and located beside the plate of the trigger unit.

6. The nailer as claimed in claim 5, wherein the pushing end of the safety device is pushed toward the heads of the nails by the spring.

7. The nailer as claimed in claim 5, wherein the pushing end is located between the magazine and the trigger unit.
